(19) United States
(12) Patent Application Publication
(10) Pub. No.: US 2009/0194951 A1
(43) Pub. Date: Aug. 6, 2009

(54) Cooling system for injection sealant stuffing box

(75) Inventor: Roni Cohen Zada Vaizman, Beer Sheva (IL)

Correspondence Address: ROBERT G. LEV, 4766 MICHIGAN BLVD., YOUNGSTOWN, OH, 44505, US

(73) Assignee: Tamar Technological Development Ltd., Omer (IL)

(21) Appl. No.: 12/221,164

(22) Filed: Jul. 30, 2008

Related U.S. Application Data
(60) Provisional application No. 61/026,019, filed on Feb. 4, 2008.

(51) Int. Cl. F16J 15/18

(52) U.S. Cl. 277/513

(57) ABSTRACT

A conduit for a cooling liquid, said conduit for substantially contacting a viscous fluid type sealant within a stuffing box, thereby conducting heat away from said sealant within said stuffing box by flowing said cooling liquid though said conduit.

### PRIORITY INFORMATION

The present invention claims priority to Provisional Application No. 61/026,019 filed Feb. 4, 2008.

### FIELD OF THE INVENTION

The present invention relates to sealing systems, and particularly to viscous sealant type sealing systems for sealing between the aperture of a machine housing and a shaft protruding through the aperture, such as are used for rotary machines and the like.

### BACKGROUND OF THE INVENTION

Many types of heavy machinery, such as pumps, compressors, turbines and the like, have drive shafts protruding from a working fluid enclosed within a working chamber. Although the clearance between the shaft and the machine housing aperture is relatively small, there is a tendency for the working fluid to leak through such apertures and a sealing system is generally used to prevent or at least to minimize such leakages.

Numerous types of sealing systems are known. One known type that is generally appropriate for low speed rotary machines, uses spring loaded gaskets, such as O-rings. For high speed rotary machines, one widely used sealing system type includes mechanical seals, which consist of radial planar surfaces normal to the shaft axis, both being machined to low surface roughness. One surface is gasketed to the housing while a second surface is driven by the shaft and sealed thereon by a secondary seal such as a bellows, for example. Such mechanical seal systems are generally expensive and the seals tend to rupture catastrophically without warning. Furthermore, the repair of a faulty mechanical seal is costly and time consuming, necessitating extensive machine downtime.

Another type of sealing system appropriate for high speed rotary machines includes compression braided packing seals. This type of seal abrades the shaft surface during tightening and adjustment procedures. Although the braided packing slowly loosens, providing early indication of leakage, the packing material is eroded relatively quickly, and needs frequent replacement, which is typically time consuming. Such seals operate by controlled leaking to keep the compression rope wet. Consequently this type of sealing system is unsuitable for applications wherein spillage of the working materials must be avoided, such as for pumping hazardous substances, for example.

One improved type of sealing system uses a high-viscosity sealant within a stuffing box. The high-viscosity sealant is typically made of a blend of synthetic fibers, lubricants, and binding agents, and has the properties of a non-Newtonian fluid.

Sealant materials are commercially available from several manufacturers, such as U-PAK® manufactured by UTEX Industries, Inc., the Sealital® series by Unique Polymer Systems, and Liquilon® available from Oil Center Research.

Generally, such a sealant is injected into the stuffing box via an inlet port. Following injection of the sealant into the stuffing box, the inlet port is plugged and pressure is applied, causing the sealant to be pressed against the shaft, thereby promoting its adhesion therewith, sealing the space between the shaft and the perimeter of the aperture. To prevent leakage of the working fluid, the pressure within the stuffing box must be maintained at a high enough level. Since frictional forces between the shaft and the sealant abrade the sealant, additional sealant must be added from time to time.

Too much sealant results in excess work being required to turn the shaft, and this work causes heat to build up within the sealing system.

Copending WO 2007/099535 to the applicants of this application, titled “Apparatus for delivering sealant at a predetermined pressure to a stuffing box of a shaft”, which is incorporated by reference for all purposes as if fully set forth herein, discloses a low cost and low maintenance apparatus for delivering viscous sealant to a stuffing box and maintaining it at a predetermined pressure. By delivering the sealant at the predetermined pressure, the apparatus described reduces or prevents sealant overheating at low machine velocities.

When it is desired to operate rotating machinery at high torques, the sealant pressure is typically increased. However, the lost work, i.e. the work expended as a result of the frictional forces between the rotating shaft and the sealant, correspondingly increases. The lost work is directly proportional to the product of the shaft diameter, rotational speed of the shaft, and the frictional forces between the shaft and the sealant that adheres to the wall of the corresponding shaft aperture. The lost work is dissipated as heat, causing the temperature of the sealant to increase. When the sealant temperature exceeds its operating temperature, risk of loss of sealing ability and even of flammability may exist. In addition, the operability of the machine may be compromised as a result of heat transfer from the sealant to the working fluid. Although the lost work could be decreased by changing the operating conditions of the rotary machine, such as working fluid pressure or shaft speed, such lowering may undesirably reduce the amount of work that the machine does and the range of applications for which such viscous, non-Newtonian sealants can be used, and it is an aim of the invention to minimize such heat build up, thereby increasing the working range of such sealing systems.

To prevent overheating with both mechanical seals and compression braided packing seals, water cooled stuffing boxes have been used. In some systems, water cooled sleeves are used, and in others water cooled pipes are deployed within the stuffing boxes.

U.S. Pat. No. 5,125,792 describes a heat exchange device for a pump stuffing box, in which cooling liquid enters the stuffing box, cools it and then enters the seal chamber as a lubricant. Although this system is appropriate for braided seals, it is inappropriate for high-viscosity, injectable sealants.

Japanese Patent Publication No. 63214576A2 relates to a shaft seal device with a stuffing box which is cooled by water flowing through a water jacket.

Japanese Patent Publication No. JP11082754A2 relates to a cooling device for a mechanical seal wherein the cooling chamber is a cooling tube inside the stuffing box, and the cooling water is circulated around a rotary shaft.

In Japanese Patent Publication No. JP10274158A2, cooling is effected in a plunger pump by arranging cooling liquid passages which are extended in an axial direction of a plunger along a seal member for cooling the seal member by means of a cooling liquid supplied from a cooling liquid supplying means.

In Japanese Patent Publication No. JP11230685A2, a heat exchanger is provided to protect a mechanical seal at a bearing of a pump. The heat exchanger includes a heat transfer tube singly wound into a coil and piped around a cylindrical shell.

U.S. Pat. No. 3,477,729 describes a method and apparatus for cooling a rotating shaft seal, wherein the stuffing box is connected to a coil within a heat exchanger with a primary coolant and the heat exchanger is supplied with a second coolant whereby heat is transferred from the primary coolant to the secondary coolant.

None of the above cooling systems apply to viscous sealants within stuffing boxes.

### SUMMARY OF THE INVENTION

It is an aim of embodiments of the present invention to increase the operating range of sealing systems of the type that includes viscous sealants within stuffing boxes.

One aspect of the invention is directed to providing a conduit for a cooling liquid, said conduit for substantially contacting a viscous fluid type sealant within a stuffing box, proximal to the shaft, thereby conducting heat away from said sealant within said stuffing box by flowing said cooling liquid though said conduit.

A second aspect is directed to providing a sealing system for sealing between an aperture of a machine housing and a rotating shaft of the machine protruding through the aperture, said sealing system comprising:

i) a stuffing box for encasing a segment of said shaft and the aperture of the machine housing;

ii) a sealant injector for injecting a viscous fluid type sealant into the stuffing box;

iii) at least one conduit as described hereinabove, for passage of a cooling fluid therethrough to cool the sealant thereby.

Optionally the conduit extends substantially through the viscous sealant within said stuffing box.

Alternatively, the conduit extends substantially around the inside of the stuffing box.

Optionally, the conduit in the sealant system comprises at least one coolant pipe within the stuffing box.

Optionally, at least one section of said at least one coolant pipe is coiled.

Optionally, the sealing system further comprises an extension coupled to the stuffing box, distal to the aperture of said machine housing, for retrofitting to conventional stuffing box, wherein said pipe is coupled to the extension.

Optionally, the pipe and the extension are retrofittable to the stuffing box, the extension having inlet and outlet holes bored therethrough for coupling the pipe to a coolant fluid supply.

Optionally, the pipes, the extension and the sealant injector are retrofittable to the stuffing box, said extension having holes bored therethrough for injecting the sealant into the stuffing box thereby, and at least one inlet and one outlet for coupling the coolant pipe to a source of cooling liquid.

The conduit extending substantially around the inside of the stuffing box in the sealing system may comprise an inner cooling sleeve for lining at least part of the stuffing box, wherein said conduit is defined by an inner surface of the stuffing box and an outer surface of the cooling sleeve.

In some embodiments, the conduit is further defined by at least one baffle between the inner surface of said stuffing box and the outer surface of the cooling sleeve, said baffle for directing cooling fluid flow around the conduit.

The sealing system may further comprise an extension coupled to the stuffing box, distal to the aperture of said machine housing, for retrofitting to conventional stuffing box, wherein the inner cooling sleeve is coupled to said extension, and said conduit is defined by inner surfaces of the stuffing box and the extension, and an outer surface of the cooling sleeve.

Optionally, the inner cooling sleeve and the extension are retrofittable to the stuffing box, the extension having inlet and outlet holes bored therethrough for coupling the conduit to a coolant source.

Optionally, the sealant injector is retrofittable to the stuffing box, the extension further having a hole bored therethrough for serving a sealant inlet port.

Optionally, inlet of the conduit is connectable to a source of cooling fluid and an outlet of the conduit is connectable to a drain.

Alternatively, the conduit is connectable via a pump to a reservoir of cooling fluid for recirculating the cooling fluid therearound.

Another aspect is directed to a method of cooling a viscous fluid type sealant within a stuffing box of a system comprising a sealant injector, a stuffing box and a shaft of a machine, the method comprising flowing a cooling liquid within a conduit in contact with said sealant, thereby conducting heat away from said sealant.

As referred to herein, the following terms have the respective following meanings:

“Sealant” or “viscous fluid type sealant”: a high-viscosity non-Newtonian liquid, i.e. a liquid whose viscosity varies as a function of the shear stress applied thereto.

“Shaft”: either a rotary shaft or a linearly displaceable shaft, such as a shaft that reciprocates with respect to a machine housing.

“Shaft aperture”: an aperture in a machine housing, through which a shaft extends.

“stuffing box” an enclosure around a shaft and the aperture of a machine housing for filling with sealing material to minimize leakages of working fluid from within the machine housing.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a vertical cross section of a prior art stuffing box including a sealant injection system, as disclosed in copending PCT application WO 2007/099535;

FIG. 2a is a vertical cross section through an embodiment of an improved sealing system, comprising a coiled coolant pipe surrounding a drive shaft, having coolant inlet and outlet extending through the walls of the stuffing box;

FIG. 2b is an embodiment of another improved sealing system comprising a coolant pipe, the system further comprising an extension for retrofitting a cooling system to a conventional stuffing box;

FIGS. 3a and 3b show a specific embodiment of an improved sealing system including conduits with pipes that extend through the sealant within the stuffing box, and particularly showing how forced cooling conduits can be introduced via a sealing flange into a stuffing box, to cool the sealant; FIG. 3a is a cross section through the system, FIG. 3b is a plan section of the system with just the pipes, flange and sealing rings shown for clarity.

FIG. 4a is a vertical section through a preferred embodiment, wherein the conduit for cooling fluid is defined by an inner surface of a countersunk stuffing box and an outer surface of a cooling sleeve inserted into the stuffing box, around the shaft, for cooling the sealant between sleeve and shaft, by extracting heat through the sleeve. The sealant supply inlet and the coolant inlet and outlet ports are in an extension that is attached to the stuffing box.

FIG. 4b is a cutaway isometric projection of another embodiment of the sealing system with a conduit for cooling fluid defined by an inner surface of a stuffing box and an outer surface of a cooling sleeve, wherein the sealant supply inlet and coolant outlet and outlet ports extend through the walls of the stuffing box.

FIG. 5a is a cutaway isometric projection from above, showing a further embodiment of an improved sealing system with a cooling sleeve that is designed for fitting into a counter-sunk stuffing box, the conduit for cooling fluid being defined by an inner surface of the stuffing box and an outer surface of the cooling sleeve, the conduit being further defined by a series of baffles that span between the inner surface of the stuffing box and the outer surface of the cooling sleeve;

FIG. 5b is a cutaway isometric projection of the system shown FIG. 5a, shown from below with the shaft removed, and FIG. 5c is a view of the outer surface of the opened out and flattened sleeve.

FIG. 6 is an isometric projection of an improved sealing system, the system including a conduit for a cooling liquid having a coolant inlet and a coolant outlet.

### DETAILED DESCRIPTION OF PREFERRED EMBODIMENTS

One improved type of sealing system for preventing or minimizing leaks of working fluid through apertures of working chambers in many types of heavy machinery includes a high viscosity, injectable sealant within the stuffing box. The sealant is typically a highly viscous organic based composite material with the consistency of modeling clay. Consequently, when deployed in stuffing boxes around drive shafts, movement of the drive shaft results in work being offset by friction, and the generation of heat. Such sealants typically have poor heat conduction and as the machine operates, the temperature thereof is apt to rise.

When the temperature of such sealants is allowed to rise beyond a safe working temperature, their properties change and they may decompose or even catch fire. In addition, the operability of the process machine might be compromised as a result of heat transfer from the sealant to the working fluid. Consequently, previous sealing systems using such sealants have been limited in their application to systems with low tangential speeds, typically 3-5 m/s. Embodiments of the present invention are directed to increasing the effective working range of viscous sealant type sealing systems by at least partly removing the heat generated and thus controlling the temperature of the sealant at an acceptable level.

Embodiments of the present invention address the problem of over-heating the viscous sealant of viscous sealant type sealing systems by actively removing heat therefrom via forced water cooling.

Although not previously used with viscous sealant type seals, water cooling has been extensively used with both mechanical seals and compression braided packing seals, and its effectiveness is known.

Since mechanical and compressed packing seals are solid, cooling of such seals may be carried out by passing the coolant directly over surfaces of the seals. Such direct cooling is unsuitable for viscous sealant type seals because the coolant mingles with the sealant and ruins it.

The water cooling of mechanical seals and compression rope packing seals requires careful positioning of water cooling conduits with respect to the solid packing materials. Therefore, such sealing systems have to be specially designed, and it is not generally feasible to convert existing mechanical seals to extend their range by retrofitting liquid cooling systems thereto. Furthermore, rebuilding or replacing the stuffing boxes of conventional sealing systems typically results in downtime of the machines.

According to embodiments of the present invention, a liquid conduit is used for cooling the viscous sealant within the stuffing box of a sealing system. One advantage of viscous sealing systems with such conduits is that it is surprisingly simple and straightforward to retrofit coolant conduits to stuffing boxes of conventional sealing systems, for example, by removing a mechanical or packing seal from a machine's conventional stuffing box, then inserting a conduit into the same stuffing box, the conduit being coupled to an extension flange with holes therethrough for inlets and outlets for the coolant conduit and for a viscous sealant injection port. Such an extension flange may have the holes preformed and the conduit already connected to the extension flange for quick retrofitting. The extension flange provides a convenient means of adding sealant or adding and removing cooling fluids to the respective parts of the stuffing box. Indeed, if, with time, there should no longer be a need for cooling the sealant, perhaps due to sealants having a wider range of operating temperatures becoming available, or the machine being operated intermittently or at lower tangential speeds so less heat is generated, the cooling system may be removed. In some instances, rotating machines incorporating such systems may be operated continuously whilst effecting the retrofitting or removal of cooling systems to and from the stuffing boxes thereof.

The present invention is directed to sealing systems including a viscous sealant that include systems for cooling the viscous sealant thereof, and including a means for delivering viscous sealant at a predetermined pressure to a stuffing box of a rotary machine such as a pump, compressor, or turbine, which transmits work by means of a shaft. In preferred embodiments, the heat removal system is retrofittable to preexisting stuffing boxes and may also be easily removed from the stuffing box. Fluid coolant is pumped through conduits that contact the sealant and conduct heat away from the sealant. However, it is noted that the coolant itself does not contact the sealant.

The following descriptions relate to the cooling of a sealant surrounding a rotary shaft, but it will be appreciated that in some instances embodiments of the invention can be implemented with cool viscous sealants surrounding linearly displaceable shafts.

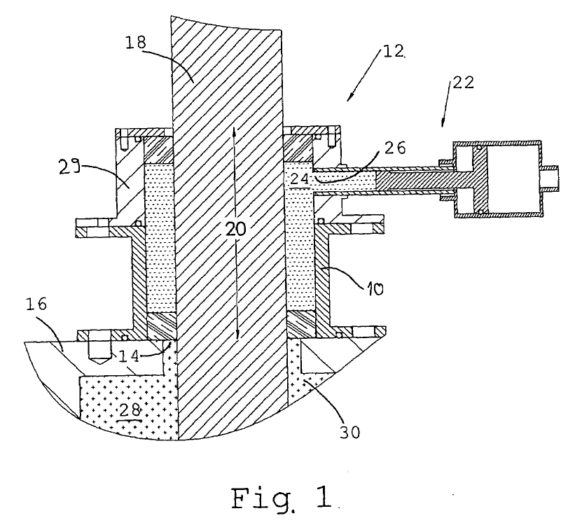

FIG. 1 shows a vertical cross section through a prior art stuffing box 10 of sealing system 12, for sealing between an aperture 14 of a machine housing 16 and a rotating shaft 18 protruding through the aperture 14. The system 12 includes: (i) a stuffing box 10 for encasing a segment 20 of the shaft 18 and the aperture 14 of the machine housing 16;

(ii) a sealant delivery unit 22 for delivering a viscous fluid type sealant 24 into the stuffing box 10, and (iii) an extension 29 for extending the stuffing box, that includes a sealant delivery port 26. The machine housing 16 is attached to one end of the stuffing box 10, and the extension 29 is attached to the other end. By virtue of such an extension 29, a conventional prior art sealing system without viscous sealant may be converted into a system that includes a viscous sealant injector. Other sealing systems may simply consist of a stuffing box and a sealant delivery unit such as described in WO2007/099535 incorporated herein by reference that may for example replace a stuffing box without viscous fluid sealant.

The viscous fluid type sealant 24 is a high-viscosity, non-Newtonian liquid that is typically a blend of synthetic fibers, lubricants, and binding agents (such as commercially available under trade name

U-PAK® manufactured by UTEX Industries, Inc, the Sealital® series by Unique Polymer Systems, and Liquilon® from Oil Center Research, for example) that is introduced from sealant delivery unit 22 via sealant inlet port 26. The combined effect of the sealant 24 pressure within stuffing box 10 and the surface tension between the sealant 24 and shaft 18 is sufficient to prevent the passage of the working fluid 28 from working chamber 30 into stuffing box 10.

There is an effective upper limit to the operability of machines with sealing systems including viscous sealants within stuffing boxes, due to overheating of the sealants at high speeds of rotation, large shaft diameter, and/or high pressure or combinations of these factors. To increase the effective range of such machines, the invention described hereinbelow provides an improved sealing system which includes conduits for cooling liquid, which are effective in cooling the sealant.

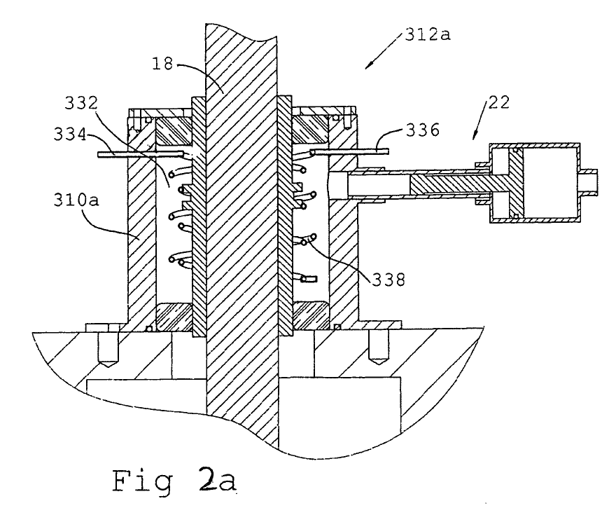

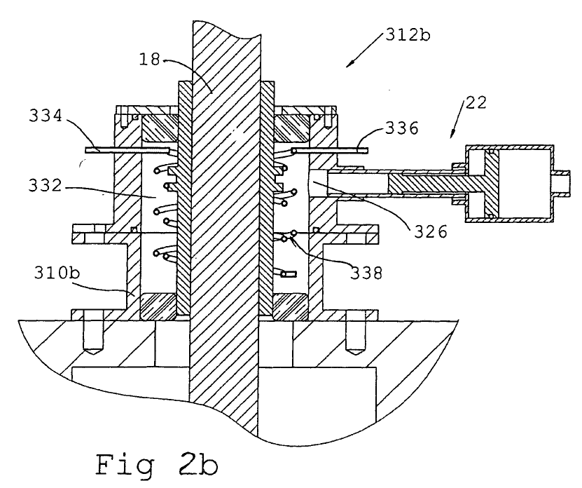

With reference to FIG. 2a, a section through an improved sealing system 312a is shown. In this specific embodiment, a conduit including a coiled pipe 338 extends through the sealant cavity 332a around the shaft 18. A cooling liquid enters the cooling box 310a via inlet 334, flows in pipe 338 encircling shaft 18 and exits the stuffing box 310a via outlet 336.

As shown in FIG. 2b, the improved sealing system 312b may include an extension 329 which includes holes for the sealant inlet port 326 and for inlet 334 and outlet 336 for the cooling conduit 338. The extension may be retrofittable to a conventional sealing system with stuffing box 310b that does not include an sealant injection aperture. Alternatively, an extension including holes for inlet and outlet for the cooling conduit but without a hole for a sealant inlet port may be retrofittable to a conventional sealing system with a stuffing box already including a sealant inlet port (not shown).

The conduit contacts the viscous sealant within-the stuffing boxes 310a, 310b and extracts heat therefrom, thereby preventing overheating of the sealant and increasing the range in which the systems 312a, 312b can operate.

It is to be appreciated that the transfer of heat from the sealant to the cooling liquid is generally improved by close proximity of the conduit to the shaft 18. On the other hand, the farther the conduit is from the shaft 18, and thus closer to the external wall of the stuffing boxes 310a, 310b, the generally larger is the surface, that may extract heat from the sealant. Also, vibrations of the shaft 18 during operation of the machine may necessitate distancing the conduit from the shaft 18 to prevent friction therebetween during operation of the machine.

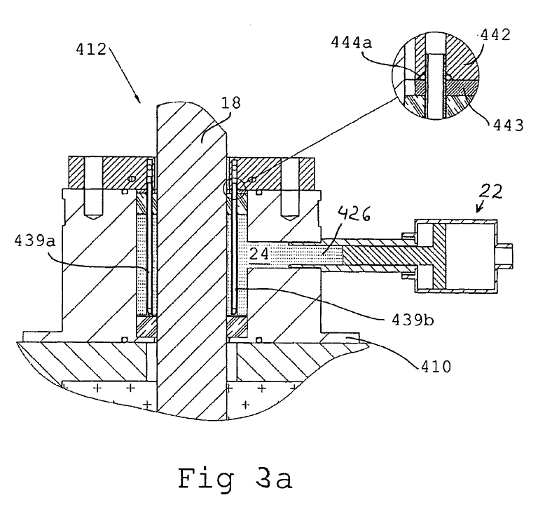

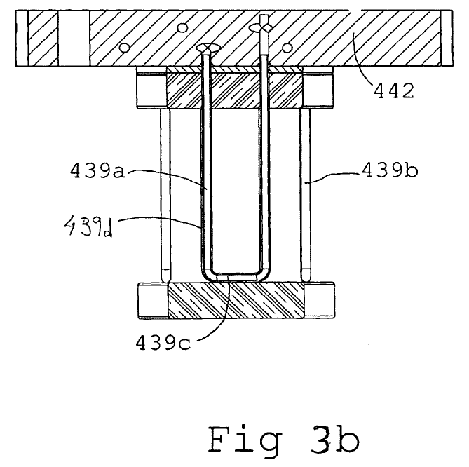

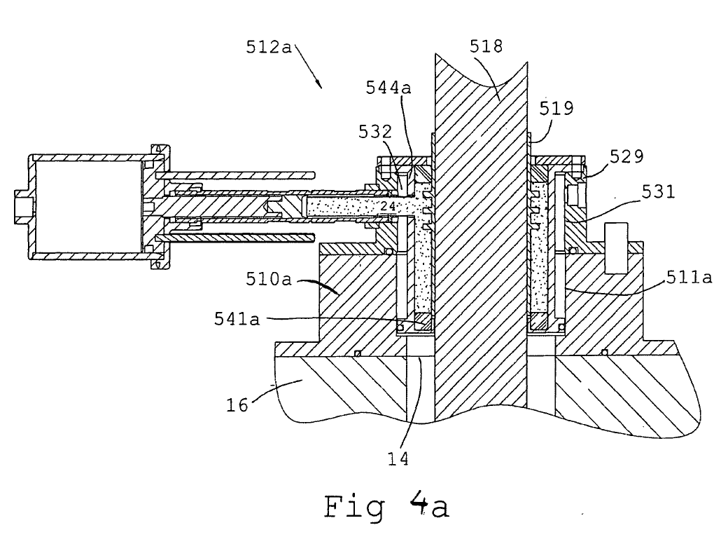

In FIGS. 3a and 3b a specific embodiment of an improved sealing system 412 is shown, wherein the conduits for cooling fluid include a series of pipes 439a, b which are coupled to a flange-type extension 442 and sealed thereto with O-rings 444 appended to a gasket plate 443. FIG. 3a shows a vertical cross section through the improved sealing system 412, showing two of the coolant pipes 439a, and 439b. The system is ideal for retrofitting to a conventional stuffing box 410 to add a cooling system for cooling the sealant 24. FIG. 3b shows the extension with the sealant delivery unit 22, the stuffing box 410 and the shaft 18 removed for clarity, and illustrates how the pipes 439a-d and extension 442 are retrofittable to a stuffing box 410 of a sealing system already equipped with a viscous sealant delivery unit 22 coupled to the stuffing box 410, around a shaft 18 therethrough.

In some embodiments of the invention, the cooling system includes a conduit that extends substantially through the viscous sealant within the stuffing box. In other embodiments of the invention, the system includes a conduit that extends substantially around the inside of the stuffing box. This increases the contact area between the conduit and the sealant in the stuffing box and makes maintenance easy.

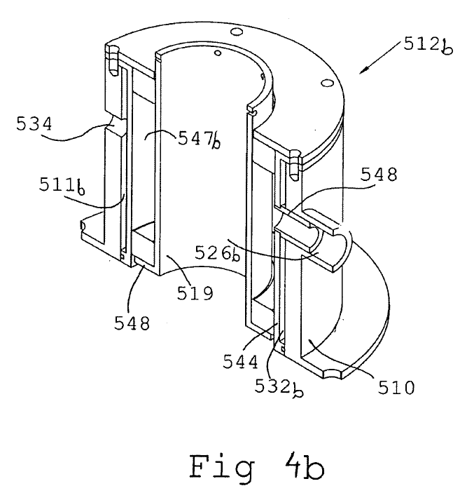

With reference to FIG. 4a, a further embodiment of the improved sealing system 512a is shown in vertical cross section. The improved sealing system 512a includes a conduit 532a defined on the outer side by the inner surface 511a of a stuffing box 510a and the inner surface 531 of an extension 529 and on the inner side by the outer surface 545a of a cooling sleeve 544a. In this embodiment, the extension 529 and the cooling sleeve 544a of the improved sealing system 512a may be retrofitted to the stuffing box 510a of a machine with a conventional seal.

FIG. 4b shows another embodiment of a cooling system 512b with the shaft and the sealant injector removed for clarity. The stuffing box 510b has holes bored through it for the sealant inlet port 526b and for the inlet 534b and outlet (not shown) of the cooling conduit 532b, respectively.

It is necessary to connect the viscous sealant injector to the space between the shaft and the inner surface 547b of cooling sleeve 544b. This may be achieved in a number of ways. In one embodiment, a feed-through 548 connects the sealant inlet port 526b and the sleeve 544b. The feed-through 548 may be flexible, by consisting of a pliant material such as rubber, PTFE, EVA, polyester, polyurethane, polyether, polyamide, polyacrylate, polyester-b-polyurethane block copolymer, polyether-b-polyurethane block copolymer, or polyether-b-polyamide block copolymer, for example. Flexibility of the feed-through may facilitate quick connection and removal of the sealant delivery unit to the stuffing box 510b for easily servicing the sealing system or the machine, such as for routine maintenance of the sealant delivery unit 522, for example, replacement or replenishment of the sealant 24 in the sealant delivery unit 522, or servicing the stuffing box 510b.

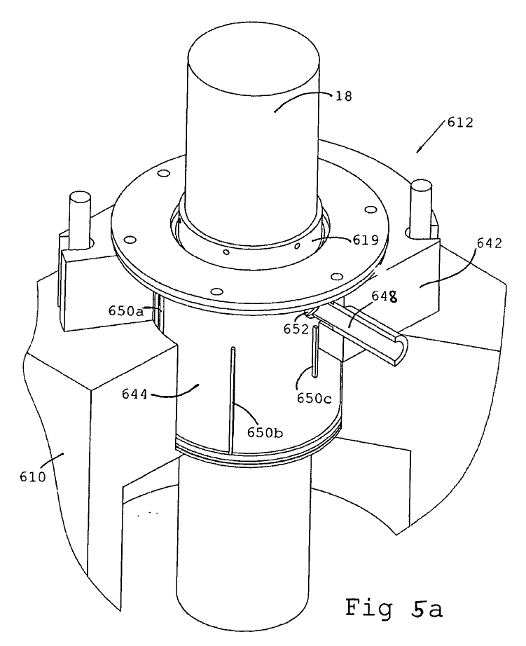

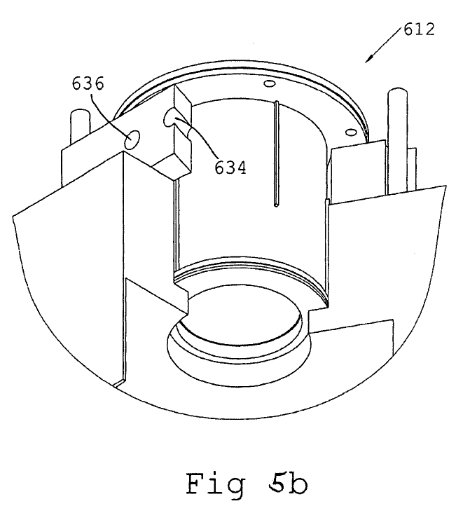

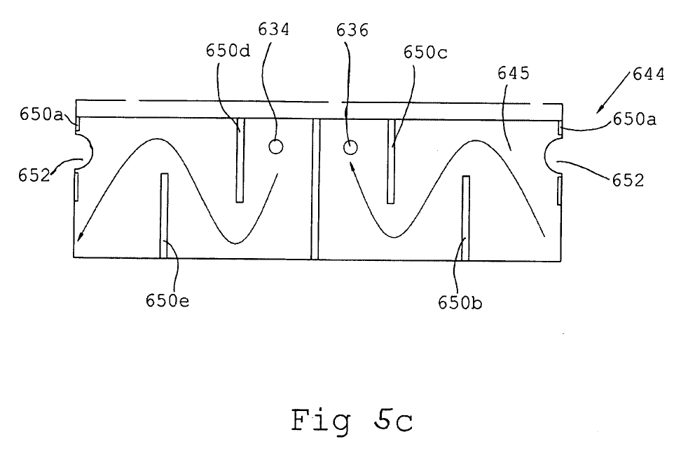

FIG. 5a shows a cutaway isometric view of an improved sealant system 612 in accordance with yet another embodiment, including a conduit defined by the inner surfaces of the stuffing box 610 and of the extension 642 respectively, and the outer surface of the cooling sleeve 644. Sealant feed-through tube 648 and sealant opening 652 through which the sealant may enter the stuffing box 610 into the space between the sheath 619 and the cooling sleeve 644 are also shown, but the sealant delivery unit itself has been removed from the figure for clarity. In this embodiment, the coolant conduit is further defined by a series of baffles 650a-c between the inner surfaces of the stuffing box 610 and extension 642, and the outer surface of the cooling sleeve 644. The improved sealing system 612 shown may be retrofitted to a machine with a stuffing box 610 of a conventional sealing system. The baffles 650a-c direct the flow of the cooling fluid around the stuffing box 610, to improve the extraction of heat from the sealant therewith.

FIG. 5b shows a cutaway isometric view of improved sealant system 612 from a different perspective, showing inlet 634 and outlet 636 for cooling fluid, but not showing the shaft.

FIG. 5c is a panoramic view showing the outer surface 645 of cooling sleeve 644 as if opened out and flattened, i.e. a 360° view therearound. Five such baffles 650a-e are shown spaced around the cooling sleeve 644 in a staggered arrangement, designed to slow the flow of coolant around the sleeve 644. Also shown are coolant inlet 634 and outlet 636. The direction of coolant flow around the baffles 650 is shown with arrows.

It will be appreciated that the conduit may vary considerably. The shape, contours and size of the conduit, as well as the materials from which it is constructed, may be specified in accordance with the machine's load, the working fluid, the sealant, the environment surrounding the machine, and other parameters which one skilled in the art may consider relevant. However, an assembled improved sealing system may merely have the coolant inlet and outlet visible, the conduit itself being invisible.

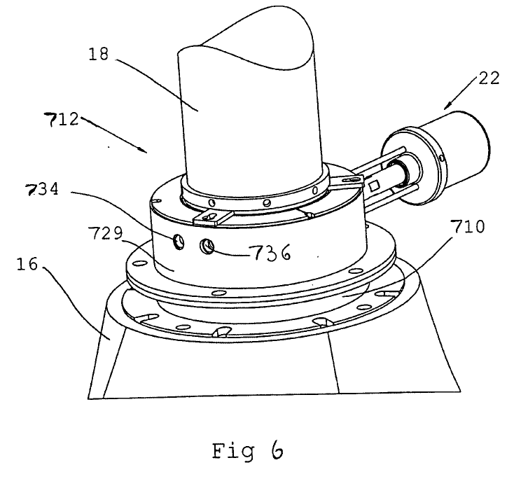

For example, with reference to FIG. 6, one embodiment of an improved sealing system 712 for sealing between a machine housing 16 and a machine's rotating shaft 18, protruding from machine housing 16 is shown. The improved system 712 consists of a stuffing box 710 and a sealant delivery unit 22 and also includes a conduit within the stuffing extension 729 through which a coolant can be supplied to conduct heat away from the sealant. The coolant inlet 734 and coolant outlet 736 are shown.

The sealant pressure within the stuffing boxes of injected viscous sealant systems is sufficient to prevent the passage of the working fluid from the working chamber into the stuffing box. However, as a result of the sealant pressure, the sealant itself may leak through the aperture of the machine housing into the working chamber. To reduce such leakage, the inner wall of the stuffing box may be provided with a lip 446 (shown in FIG. 3a) proximal to the aperture, thus reducing the gap between the shaft and the walls of the stuffing box and thereby reducing the leakage. Alternatively, the cooling system feature may be combined with a sheath 519 (FIGS. 4a, 4b) affixed around the shaft 518 to rotate therewith, wherein the sheath 519 is provided with a lip 548 (FIG. 4b) radially extending from the shaft 518, proximal to the aperture 14 of the machine housing 16, which assists in retaining the sealant 24 and in holding seal 541a in place within the stuffing box 510. In sealing systems which include such a sheath 519, the seals 541 rotate with the shaft 518, and the sealant 24 in proximity to the lip 548 is forced outwards by centrifugal force. Although in such systems 512 there is an increased area for the sealant to leak out of stuffing box 512 compared to the surface area available for leakage in other sealant systems, such as where the lip is on the stuffing box, radially extending towards the shaft, for example, it has surprisingly been found that the sheath 519 with a lip 548 extending from the shaft usefully provides improved leakage-prevention.

As the shaft 518 rotates within the sealing system 512, friction with the viscous sealant 24 generates heat. Unlike conventional rope seals which continuously leak, thereby wetting and cooling the seal, the sealing system 512 of the present invention is essentially a leak-free solution. Consequently, since friction would otherwise limit the sealing system 512 being operated at faster speeds of rotation, cooling the sealant 24 is particularly important when the sealing system 512 includes the sheath 519 with lip 548.

Features shown with some specific embodiments may be incorporated with other embodiments. Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

I claim:

1. A conduit for a cooling liquid, said conduit for substantially contacting a viscous fluid type sealant within a stuffing box, thereby conducting heat away from said sealant within said stuffing box by flowing said cooling liquid though said conduit.

2. A sealing system for sealing between an aperture of a machine housing and a rotating shaft of the machine protruding through the aperture, said sealing system comprising:
a stuffing box for encasing a segment of said shaft and the aperture of the machine housing; a sealant injector for injecting a viscous fluid type sealant into the stuffing box; at least one conduit of claim 1 for passage of a cooling fluid therethrough to cool the sealant thereby.

3. The sealing system of claim 2, the conduit extending substantially through the viscous sealant within said stuffing box.

4. The sealing system of claim 2, said conduit comprising at least one coolant pipe within the stuffing box.

5. The sealing system of claim 4, at least one section of said at least one coolant pipe being coiled.

6. The sealing system of claim 4, further comprising an extension coupled to the stuffing box, distal to the aperture of said machine housing, for retrofitting to a conventional stuffing box, wherein said pipe is coupled to the extension.

7. The sealing system of claim 6 wherein the pipe and the extension are retrofittable to the stuffing box, the extension having inlet and outlet holes bored therethrough for coupling the pipe to a coolant fluid supply.

8. The sealing system of claim 6 wherein the pipe and the extension are retrofittable to the stuffing box, the extension having inlet and outlet holes bored therethrough for coupling the pipe to a coolant fluid supply.

9. The sealing system of claim 2, the conduit extending substantially around inside of the stuffing box.

10. The sealing system of claim 9, wherein the conduit comprises an inner cooling sleeve for lining at least part of the stuffing box, said conduit being defined by an inner surface of the stuffing box and an outer surface of the cooling sleeve.

11. The sealing system of claim 10, wherein the conduit is further defined by at least one baffle between the inner surface of said stuffing box and the outer surface of the cooling sleeve, said baffle for directing cooling fluid flow around the conduit.

12. The sealing system of claim 10, further comprising an extension coupled to the stuffing box, distal to the aperture of said machine housing, for retrofitting to a conventional stuffing box, wherein the inner cooling sleeve is coupled to said extension, and said conduit is defined by inner surfaces of the stuffing box and the extension, and an outer surface of the cooling sleeve.

13. The sealing system of claim 12, the inner cooling sleeve and the extension being retrofittable to the stuffing box, the extension having inlet and outlet holes bored therethrough for coupling the conduit to a coolant source.

14. The sealing system of claim 12, wherein the sealant injector is retrofittable to the stuffing box, said extension comprising an aperture for injection of sealant therethrough.

15. The cooling system of claim 2, the inlet of the conduit being connectable to a source of cooling fluid and the outlet of the conduit being connectable to a drain.

16. The cooling system of claim 2, the conduit being connectable via a pump to a reservoir of cooling fluid for recirculating the cooling fluid therearound.

17. A method of cooling a viscous fluid type sealant within a stuffing box of a system comprising a sealant injector, a stuffing box and a shaft of a machine, the method comprising flowing a cooling liquid within a conduit in contact with said sealant, thereby conducting heat away from said sealant.
